(19) United States
(12) Patent Application Publication
(10) Pub. No.: US 2014/0069809 A1
(43) Pub. Date: Mar. 13, 2014

(54) MACHINE FOR ELECTROCHEMICAL METAL MACHINING

(71) Applicants: Jochen Laun, Gaildorf (DE); Alexander Noller, Gaildorf (DE)

(72) Inventors: Jochen Laun, Gaildorf (DE); Alexander Noller, Gaildorf (DE)

(21) Appl. No.: 14/115,388

(22) PCT Filed: May 7, 2012
(86) PCT No.: PCT/DE2012/000472

§ 371 Date: Nov. 4, 2013

(30) Foreign Application Priority Data
May 10, 2011 (DE) 10 2011 101 100.9

(51) Int. Cl. B23H 7/26; B23H 3/00

(52) U.S. Cl. CPC B23H 7/26; B23H 3/00
USPC 204/275.1; 204/242

(57) ABSTRACT

The invention relates to a machine for electrochemical metal machining, wherein metal is removed by electrolytic dissolution of the workpiece (10), comprising a frame (1), with a work holder (19), wherein a workpiece (10) is mounted in the work holder (19) in such a way that it can be rotationally driven under numerical control about a vertical spindle axis (6) and a horizontal axis of rotation (9), with at least one tool (15), which can be infed to the workpiece (10), wherein the workpiece (10) is positively poled as an anode and the tool (15) is negatively poled as a cathode, wherein the work holder (19) is guided movably in a controlled manner in relation to the frame (1) in a horizontal direction on the horizontal slide (4) along Y guides (3) and in a vertical direction with the spindle (5) along the Z guide (16), and the tool (15) can be moved in a horizontal direction on the infeed slide (12) along the X guide (11) on the frame (1).

The invention relates to a machine for electrochemical metal machining (ECM).

During ECM machining, metal is removed by electrolytic dissolution until the desired workpiece shape is obtained. The workpiece is poled as an anode (positive) and the tool is poled as a cathode (negative), or voltage or current are pulsed bipolarly. In the working gap between the two electrodes, an electrolyte solution, for example sodium chloride or sodium nitrate, transports the charge. Since the working gap measures merely fractions of a millimeter, feed and positioning accuracy must meet the highest requirements.

DE 10 2004 040 578 [US 2004/0200807] describes an ECM machine in gantry design as known. On this known machine, a rotary table with a workpiece support fork is vertically arranged on the machine bed. The table is rotatably mounted around a vertical axis and the workpiece support can be rotated around a horizontal axis. Furthermore, a portal supported on four columns is horizontally movable on the machine bed. On the columns, two carriages connected by a crossbeam are vertically movable. The crossbeam is pivotably mounted around a horizontal axis and holds two tool cathodes that are, in turn, separately movable relative to the crossbeam. Therefore, seven numerically controlled axes are altogether provided.

The problem addressed by the present invention is that of providing a machine tool according to the preamble of claim 1 with compact design and improved machine rigidity. The problem is solved with a machine according to claim 1. Advantageous embodiments are described in the dependent claims.

In the following, the invention is further explained with reference to one embodiment.

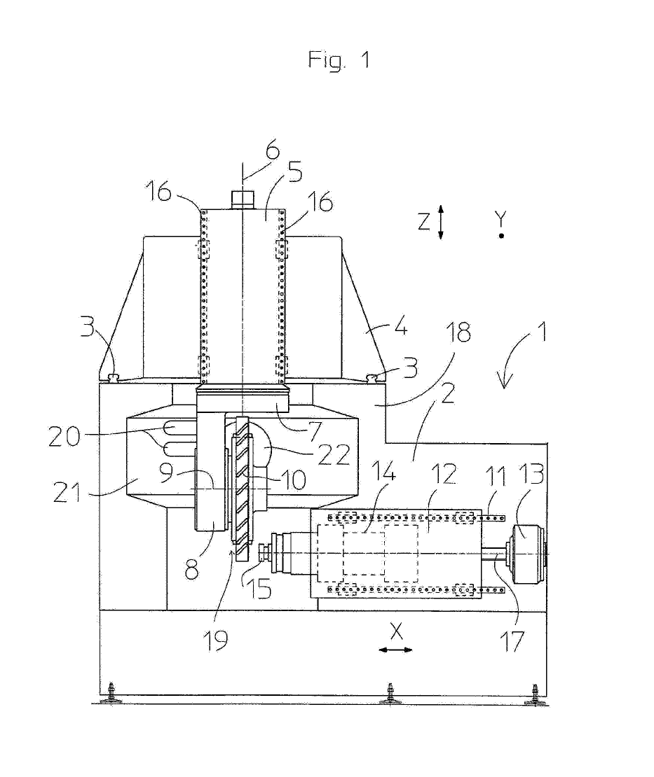

FIG. 1 is a schematic front view of a machine tool according to the invention. A frame 1 consists of a massive base body made of reaction resin concrete. The concrete is particularly torsion-resistant and ensures best thermal stability. Two vertically spaced horizontal X guides 11 for an infeed slide 12 are provided on a vertical front wall 2. The infeed slide 12 carries an oscillator unit 14 with a tool 15, negatively poled as cathode. The infeed slide 12 is infed in a controlled manner by the motor 13 via the horizontal threaded spindle 17. An oscillating working stroke is superimposed on the infeed movement using the oscillator unit 14, thus the tool 15 is reciprocated with a frequency in the order of 50 Hz parallel to the X guide. At a broad gap distance, fresh electrolyte enters the working gap and flushes the dissolved products from the gap during reapproach. A cam with adjustable stroke provides the working stroke.

On the upper side of the frame 1, a structure 18 with Y guides 3 carries a horizontal slide 4. The wide spacing of the Y guides 3 ensures utmost precision. A spindle drive 5 with Z guides 16 is vertically movable on the horizontal slide 4. On the underside, the spindle 5 carries a pivotal part 7. A bearing block 8 is attached to the pivot part 7 and can be pivoted in conjunction with the pivot part 7 around a spindle axis 6. A holder 19 for workpieces 10 is mounted in the bearing block 8 such that it can be rotated around an axis 9.

Overall, the following numerically controlled axes are realized for machining the workpieces 10:
X: Horizontal linear axis of the infeed slide 12 on the front wall 2
Y: Horizontal linear axis of the horizontal slide 4 on the upper side of the frame 1
Z: Vertical linear axis of the spindle 5 on the horizontal slide 4
B: Horizontal axis of rotation of the workpiece 10 around the axis of rotation 9
C: Vertical axis of rotation of the spindle 5 around the spindle axis 6

It is particularly advantageous that, the front wall 2, an indentation 21 for the working space opens forward in the middle portion of the frame 1 and extends upward into the structure 18. Since the spindle 5 with the workpiece 10 projects to at least some extent into the indentation 21, the spacing between where the tool engages the workpiece and the frame can be significantly decreased. This results in optimal force transmission and increased machine rigidity. In addition, the two side walls and the upper and underside of the indentation 21 are to at least some extent formed by the frame 1. This also increases the rigidity of the machine. Furthermore, a particularly compact and stable design is achieved in that the Y guides 3 for the spindle 5 and the X guides 11 for the infeed slide 12 are on two walls that are perpendicular to one another.

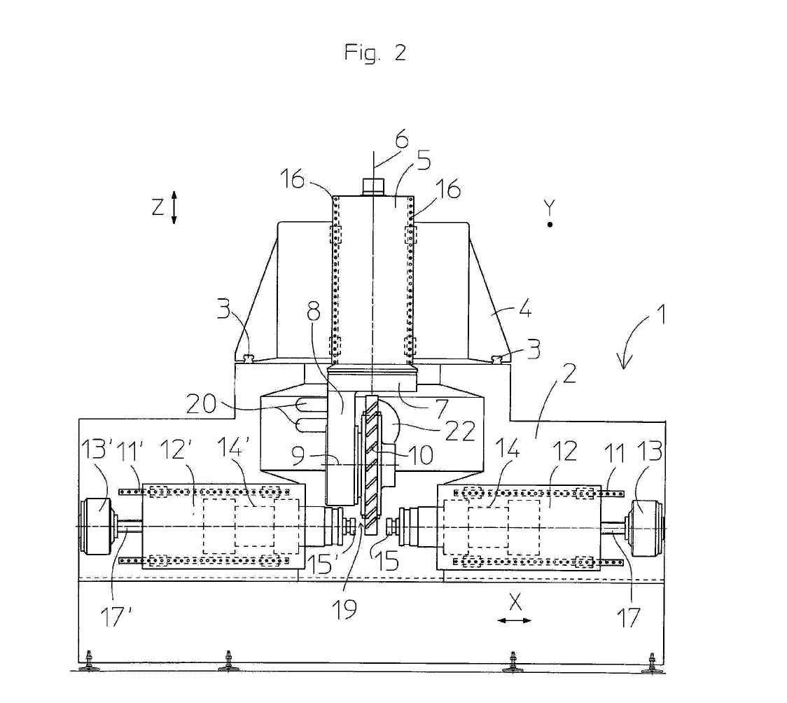

FIG. 2 show a machine constructed as a mirror image with two tools 15 and 15′. By analogy to the infeed slide 12, a further infeed slide 12′ with an oscillator unit 14′ is provided that is movable on an X guide 11′ on the frame 1 and is moved by a motor 13′ via a horizontal threaded spindle 17′. The synchronous infeeding of the tools 15 and 15′ to the workpiece 10 in opposite directions is particularly advantageous because the forces acting on the workpiece 10 from the electrolyte cancel each other out.

List of reference numerals

1 Frame
2 Front wall
3 Y guide
4 Horizontal slide
5 Spindle
6 Spindle axis
7 Pivot part
8 Bearing block
9 Axis of rotation
10 Workpiece
11 11′ X guide
12 12′ Infeed slide
13 13′ Motor
14 14′ Oscillator unit
15 15′ Tool
16 Z guide
17 17′ Horizontal threaded spindle
18 Structure
19 Work holder
20 Conduit
21 Indentation
22 Opening

1-8. (canceled)

9. An apparatus for electrochemical machining a workpiece, the apparatus comprising:
a frame;
a slide movable horizontally on the frame;
a drive movable vertically on the slide;
a workpiece holder adapted to hold a workpiece and rotatable on the drive about a vertical axis and a horizontal axis;
a tool support movable horizontally on the frame; and
a tool carried on the support and engageable with the tool, whereby, with opposite electrical polarization of the tool and the workpiece, material can be electrochemically dissolved from the workpiece.

10. The electrochemical-machining apparatus defined in claim 9 wherein the slide is movable horizontally on the frame in a first direction and the tool support is movable horizontally on the frame in a second direction substantially perpendicular to the first direction.

11. The electrochemical-machining apparatus defined in claim 10, wherein the frame has a horizontal top face and a vertical front face, the apparatus further comprising:
a Y guide on the top face, extending in the first direction, and carrying the guide; and
an X guide on the front face, extending in the second direction and carrying the drive.

12. The electrochemical-machining apparatus defined in claim 11, wherein the front wall has a cavity open horizontally in the first direction and extending vertically, the drive and holder engaging at least partially into the cavity.

13. The electrochemical-machining apparatus defined in claim 12, wherein the frame has vertical side walls flanking the cavity.

14. The electrochemical-machining apparatus defined in claim 12, wherein the frame is provided with a throughgoing opening, whereby energy and fluid can be supplied to the workpiece holder via the opening.

15. The electrochemical-machining apparatus defined in claim 9, further comprising:
a second such tool support and tool symmetrically flanking the holder with the first-mentioned tool support and tool.

16. The electrochemical-machining apparatus defined in claim 15, further comprising:
means for synchronously advancing the first and second tool supports with the respective tools toward and away from the tool holder.
